(19) United States
(12) Patent Application Publication
(10) Pub. No.: US 2010/0235217 A1
(43) Pub. Date: Sep. 16, 2010

(54) JURY SELECTION SYSTEMS AND METHODS

(75) Inventors: David Ehlert, Seattle, WA (US); Ann Rosato, Seattle, WA (US); Kristine Johnson, Seattle, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Tru-Say, Seattle, WA (US)

(21) Appl. No.: 12/631,721

(22) Filed: Dec. 4, 2009

Related U.S. Application Data
(60) Provisional application No. 61/119,890, filed on Dec. 4, 2008.

(51) Int. Cl. G06Q 50/00; G06Q 90/00; G09F 7/02; G06Q 10/00

(52) U.S. Cl. 705/9; 705/500; 40/584

(57) ABSTRACT

Systems, methods, and related programs for of jury management or selection.

### CROSS-REFERENCE TO RELATED APPLICATION

The present invention claims the benefit of priority under 35 U.S.C. §119(e) of U.S. Provisional Application No. 61/119,890, filed Dec. 4, 2008 (Attorney Docket No. 027807-000100US), the entire content of which is incorporated herein by reference.

### BACKGROUND OF THE INVENTION

Voir dire is the process by which attorneys select, or perhaps more appropriately reject, certain jurors to hear a case. When prospective jurors arrive at the court house and report for jury duty, they are typically assigned a number and they are given a short questionnaire to fill out. The questionnaire seeks information such as name, age, employment, marital status, number and age of children, prior jury service, prior involvement in lawsuits, and prior felony convictions. For a complex case, the questionnaire may be more detailed and case specific. For example, a medical malpractice case may have a questionnaire that has specific questions designed to elicit information from a juror about negative experiences with the medical community. After the prospective jurors fill out the questionnaires, copies of the completed questionnaires are given to the attorneys for each party. How much time the attorneys have to review the questionnaires can vary greatly. A typical scenario could be 30-60 minutes. For a more complex case, the attorneys might be given more time to review and digest the completed questionnaires.

Once the attorneys review the completed questionnaires, voir dire begins. The jurors are brought into the courtroom by the bailiff and are seated in the order in which their numbers have been assigned. This is the order that the jurors will remain in for the duration of voir dire. Twelve jurors (i.e., jurors 1 through 12) are seated in the jury box. These are the twelve jurors that are first in line to be seated on the jury, unless they are excused for whatever reason. An average number of prospective jurors for a standard case is typically anywhere from 35 to 50 jurors.

Once the jurors are seated in numerical order in the courtroom, the attorneys then have the opportunity to question all of the prospective jurors, with the goal being to remove those jurors that are either biased, not fit to serve on a particular case, have a hardship that makes jury service difficult, etc. Each party typically has an unlimited number of “for cause” challenges. This means that if an attorney can demonstrate that a prospective juror is incapable of being a fair juror for the particular case, the juror can be excused “for cause.” Additionally, each party has three peremptory challenges. Peremptory challenges can be used to excuse any juror for any reason without providing an explanation to the court.

How much time attorneys are given for questioning the jury panel varies greatly. Many courts give each party two 20 minutes rounds. For example, in a civil case plaintiff's counsel will question the jury for 20 minutes, then defense counsel for 20 minutes, followed by plaintiff's counsel again for 20 minutes, followed by defense counsel again for 20 minutes. There may also be a series of questions by the judge.

“For cause” challenges can be exercised at any point during voir dire. If the court grants a “for cause” challenge and a prospective juror is excused, for example, if juror #1 is excused, juror #13 moves into the seat of juror #1. Most judges don't have the juror physically get up and move into seat #1 in the jury box. Instead, the attorneys must keep track of the fact that the jury is now comprised of jurors numbered 2-13. As additional “for cause” challenges are granted, more jurors are excused. As more jurors get excused, it can become very difficult for the attorneys to keep track of which jurors comprise the actual jury of twelve. For example, if six of the jurors numbered 1 through 12 have been challenged and excused, the prospective jury is actually comprised of the remaining six jurors in the jury box, plus jurors 13 through 18.

Once the attorneys are finished questioning the prospective jurors, the court will ask the attorney for the plaintiff to exercise plaintiff's first peremptory challenge and excuse any juror in the currently comprised jury of twelve. Next, the court will ask the attorney for the defendant to exercise defendant's first peremptory challenge. As each party exercises its peremptory challenge to excuse a juror, a new juror moves (again, not physically) into the jury box to comprise the prospective jury of twelve. Once each party has either exercised all three of its peremptory challenges or has said that it is satisfied with the jury panel and is waiving any remaining peremptory challenges, voir dire is finished and the jury of twelve has been seated for the case at hand. At this point, the jury is sworn in for the case.

Organizing all of the information for each prospective juror is a very difficult task. It is very difficult to keep track of all of the relevant information on the jury questionnaires. It is also difficult to keep track of additional information provided by the jurors during the questioning process. Moreover, keeping track of which specific jurors, at a given moment in time, comprise the prospective panel of twelve is also a very difficult task.

Therefore, systems and methods are needed for improved tracking and/or organizing of selected and prospective jurors in a jury pool, as well as organizing and managing information on jurors important in the process of jury selection.

### BRIEF SUMMARY OF THE INVENTION

The present invention includes systems, methods, and related programs designed to help organize and manage the process jury management or selection.

In one aspect, the present invention includes a method for organization and/or management of a jury selection process. Such a method can include generating a juror card for each of a plurality of jurors in a jury pool, each juror card comprising information regarding the corresponding juror. The method further includes one or more of sorting the juror cards into a first group comprising a current jury panel and a second group comprising potential jurors; positioning a plurality of juror cards on a jury board in an ordered arrangement; removing a juror card from the first group, the removal tracking a removal of the corresponding juror from an actual jury panel; and adding a potential juror to the first group, wherein the potential juror is removed from the second group. Methods may be embodied in or accomplished with portable physical component designs (e.g., foldable jury board, jury cards, etc.) and/or computer executable modules or software.

Thus, in another aspect, the present invention includes a computer program product having a computer readable medium storing a set of code modules which when executed by a processor of a computer system cause the processor to execute organization and/or management instructions or tasks for a jury selection process, and render one or more images. A computer program product can include, for example, code for receiving data comprising candidate juror information; code for sorting candidate jurors into one of a first group comprising a current jury panel and a second group comprising potential jurors; code for removing a candidate juror from the first group; code for adding a potential juror to the first group, wherein the potential juror is removed from the second group; and/or code for re-sorting candidate jurors into one of a revised first group and second group following the removing and adding of jurors.

In another aspect of the present invention, a system for improved organization and management of a jury selection process is provided. A system can include a plurality of juror cards, each juror card having surface area patterned for inputting information regarding an actual juror candidate at one or more designated locations on the card surface. The system can further include a jury board having a surface area configured for positioning of a plurality of juror cards in a selected arrangement corresponding to an actual current jury panel or group of prospective jurors, wherein the juror cards are configured for removable attachment to the jury board.

For a fuller understanding of the nature and advantages of the present invention, reference should be had to the ensuing detailed description taken in conjunction with the accompanying drawings. The drawings represent embodiments of the present invention by way of illustration. The invention is capable of modification in various respects without departing from the invention. Accordingly, the drawings/figures and description of these embodiments are illustrative in nature, and not restrictive.

### BRIEF DESCRIPTION OF THE DRAWINGS

FIG. 1 illustrates a jury selection system according to an embodiment of the present invention.

FIG. 2 illustrates a jury board, according to an embodiment of the present invention, in a collapsed or folded configuration.

FIG. 3 illustrates a jury board, according to an embodiment of the present invention, in an opened configuration

FIGS. 4A and 4B illustrate, respectively, a back view and a side view of a jury board according to an embodiment of the present invention.

FIG. 5 is a flow diagram illustrating a process according to an embodiment of the present invention.

FIG. 6 illustrates an exemplary graphical display of a jury selection/organization system of the present invention.

FIG. 7 shows typical components or subsystems of a computer apparatus.

FIGS. 8A through 8C illustrate views of a jury board according to another embodiment of the present invention having a “legal folder” design.

FIG. 9 shows in interior surface view of the jury board embodiment as in FIGS. 8A-8C.

FIG. 10 shows an interior surface view as in FIG. 9, the interior surface further including juror cards positioned on the board surface.

FIG. 11 illustrates a juror information sheet or “prep form”, according to an embodiment of the present invention.

### DETAILED DESCRIPTION OF THE INVENTION

The present invention provides systems and methods for improved organization and management of a pool of jurors and, more particularly, the process of jury selection. Techniques of the present invention enable a user or attorney to have key information regarding the prospective jurors in an organized and easily accessible manner. The present invention further advantageously allows a user to visualize which jurors, at a given moment in time, compose the prospective panel of the select number jurors (e.g., 12 jurors), as well as visualization of which jurors are next in line and likely to be seated on the jury box/panel if one or more current jurors are excused. Thus, methods are provided for queue management whereby a user can keep track of and visualize which jurors are currently seated in the jury box and which jurors are next up in line to be seated in the box if those jurors currently seated in the box are excused.

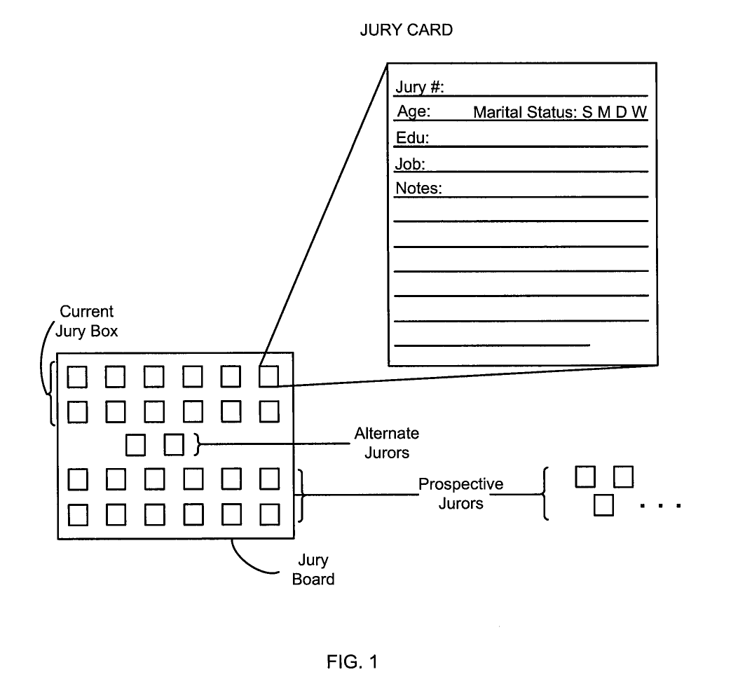

A jury selection and organization system according to an embodiment of the present invention is described with reference to FIG. 1. The system includes a jury board and a plurality of juror cards. Each juror card can have a surface area patterned (e.g., printed) for inputting information regarding a juror candidate. The patterning can designate locations on the card surface for inputting or writing information regarding an actual juror from a pool of jurors. As noted, often when prospective jurors arrive at the court house and report for jury duty, they are typically assigned a number and they are given a short questionnaire to fill out, and may include information such as name, age, employment, marital status, number and age of children, prior jury service, prior involvement in lawsuits, prior felony convictions, and the like. Information gathered can vary in level of detail and volume and may be case specific. As such, card patterning will not be limited to any particular set of designated information. Exemplary juror card patterning is illustrated in the expanded card view shown in FIG. 1. In another embodiment, a card surface may be formatted for removable writing on the surface, such as use of an erasable marker or other writing implement. Such writing implements can be included in a package or kit of the system.

As further illustrated in FIG. 1, a system of the present invention further includes a jury board. The board will typically include a surface for positioning of juror cards in a selected arrangement, and will facilitate organization and/or tracking of juror status during the jury selection process. A board surface can be substantially blank or can include any patterning that may assist in designated positioning and/or organization of the juror cards positioned on the board surface. For example, the board may include a sort of grid pattern and may include a select number of locations within the grid. The locations may be numbered or patterned to correspond with an expected number of jurors to be included in an actual jury panel. For example, an actual jury panel in a particular case may include 12 jurors and one or more alternate jurors. A jury board corresponding to such a case then may include a grid with 12 designated locations for positioning of juror cards (corresponding to actual jurors), and juror cards can be positioned within the grid during the jury selection process to track the current status of the actual jury pattern as various time points in the selection process. The jury board may further optionally include a designated area for positioning of juror cards corresponding to potential jury candidates, and may be positioned in a selected or ordered arrangement—e.g., in a sort of queue so as to allow visualization/organization of potential jurors in line for entry into the actual jury panel upon striking/removal of a juror from the current panel.

Juror cards and a jury board can include various possible configurations and constructions. Cards and a jury board will typically be configured for removable coupling of juror cards to the board. In one example, cards and a board can be configured for magnetic coupling. In such an embodiment, a card and/or the board can include magnetic elements that can be coupled for attachment of a card to the board and then easy removal of the card if and when removal is so desired. Attachment configurations are not limited to any particular construction, and can include elements suitable, for example, for adhesion, bonding, Velcro attachment, snap-on, and the like.

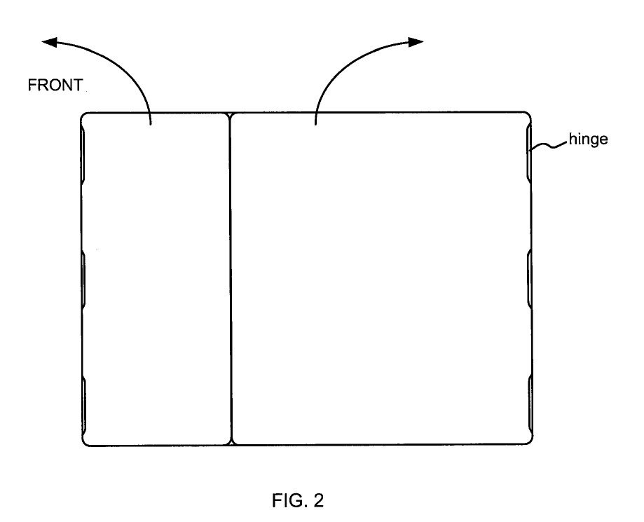

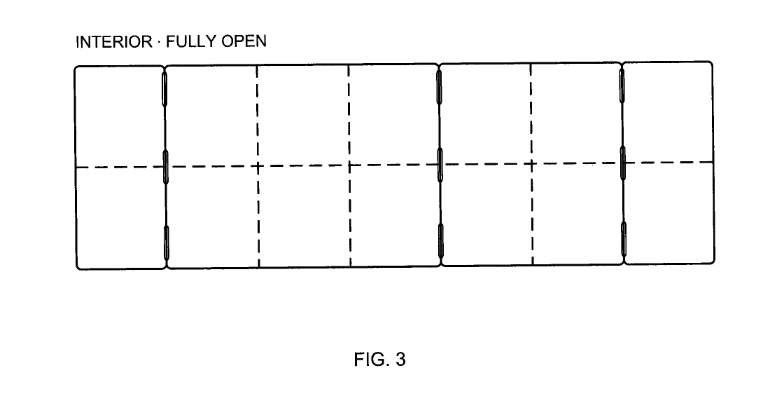

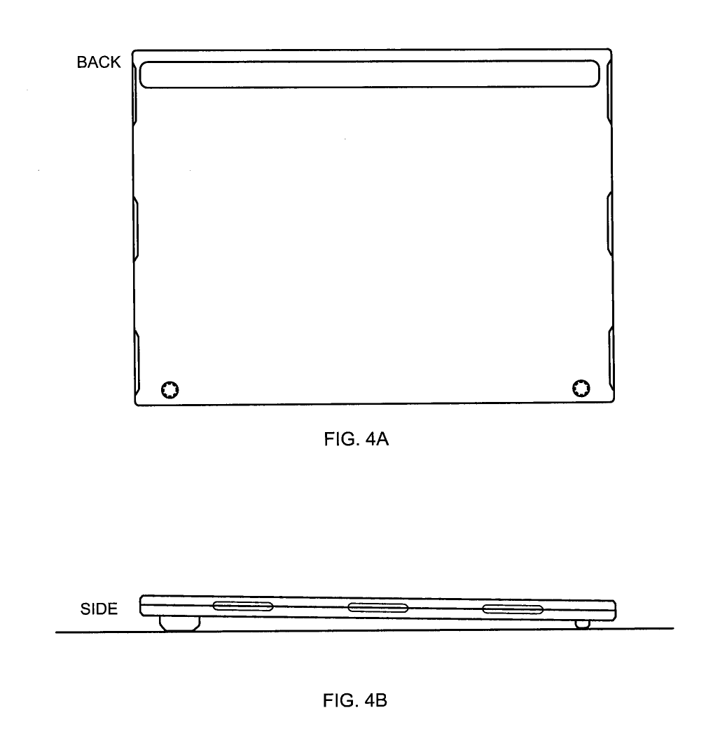

As noted above, jury boards may include various configurations and constructions, and may include single piece designs as well as multi-piece designs. A multi-piece board assembly is described with reference to FIGS. 2 through 4. Referring to FIG. 2, a multi-piece board assembly is illustrated in a folded or collapsed configuration. Elements of the board are shown attached about hinged elements, allowing elements of the board to be rotated inward or outward, as illustrated by movement arrows. FIG. 3 illustrates the multi-piece assembly positioned in an opened arrangement, where the four panels of the board are coupled about hinged elements and folded outward and opened to provide an elongated board surface. The exposed surface provided by the open board can be optionally patterned as shown to include a sort of grid designating locations for positioning of juror cards. FIGS. 4A and 4B illustrate back and side views, respectively, of the multi-piece assembly in a collapsed or closed configurations. As will be appreciated, the board can be sized and configured for convenient positioning, use, transport and the like. The board can further include bumpers on a back surface so as to provide an angled positioning of the board as the board is positioned on a surface, such as a substantially flat surface of a desk or table.

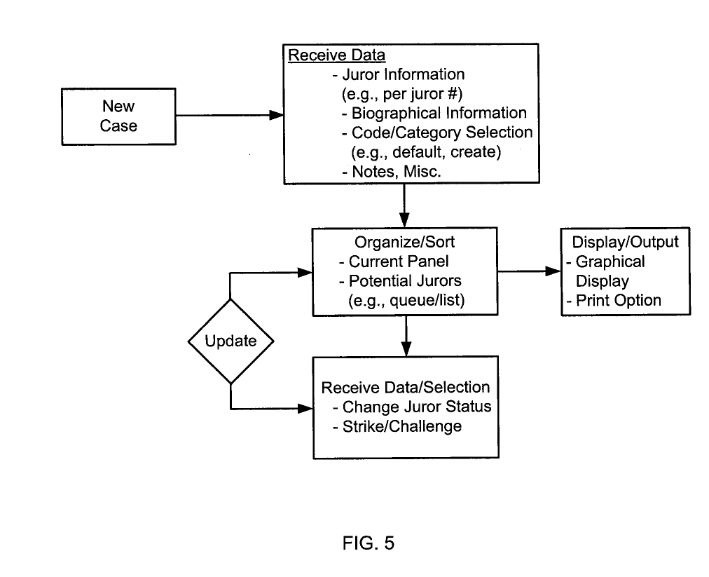

FIG. 5 provides a flow diagram illustrating a method or process according to an embodiment of the present invention. In one embodiment, the present invention can be embodied in a software program or application, such as a set of code modules or instructions stored on a component of a computer system or on a computer readable medium (e.g., memory, disk, etc.). In operation, a process can include opening or selecting a new case for management and organization according to the present invention. Next, data is received or input by a user, and can include various information as noted above, such as juror information, juror number, biographical information, notes or miscellaneous information, and the like. Information can by used to create a digital embodiment of a juror card as noted above. Information can further be input or received for coding or categorization of a juror in a manner desired by a user or from a list of default codes/categories. For example, jurors can be coded for degrees of desirability for ultimate inclusion in the actual jury panel, or flagged for such levels of desirability/suitability for jury service. Such flagging or coding can be embodied in various manners, and can include some selected indicia (e.g., numerical, non-numerical, color, etc.) corresponding to designed coding information. Following data input, jurors of the pool are organized or sorted into 2 or more groups. Groups typically include a first group of jurors that are initially designated as belonging to the current jury panel and that will compose the ultimate or final jury panel absent challenge or removal. A second group can include prospective jurors that are not initially part of the current jury panel but which may move into the panel as current jurors are struck or removed. Following sorting, data can be output for graphical display, printing, etc for visualization of sorting or organization for a user. As noted above for the process of jury selection, jurors can be challenged and removed from the current panel with prospective jurors taking their place in the panel. As such, following sorting, data can be input or received regarding removal of one or more jurors from the group of jurors composing the current panel. Following removal of a juror from the current panel, a prospective juror can be added to the first group making the current panel. A sorting or organization step is accomplished to update the designated groups based on such updated status with removal and addition of jurors to the current panel. Data input/receiving based on juror selection/removal, and group sorting can be repeated throughout the selection process.

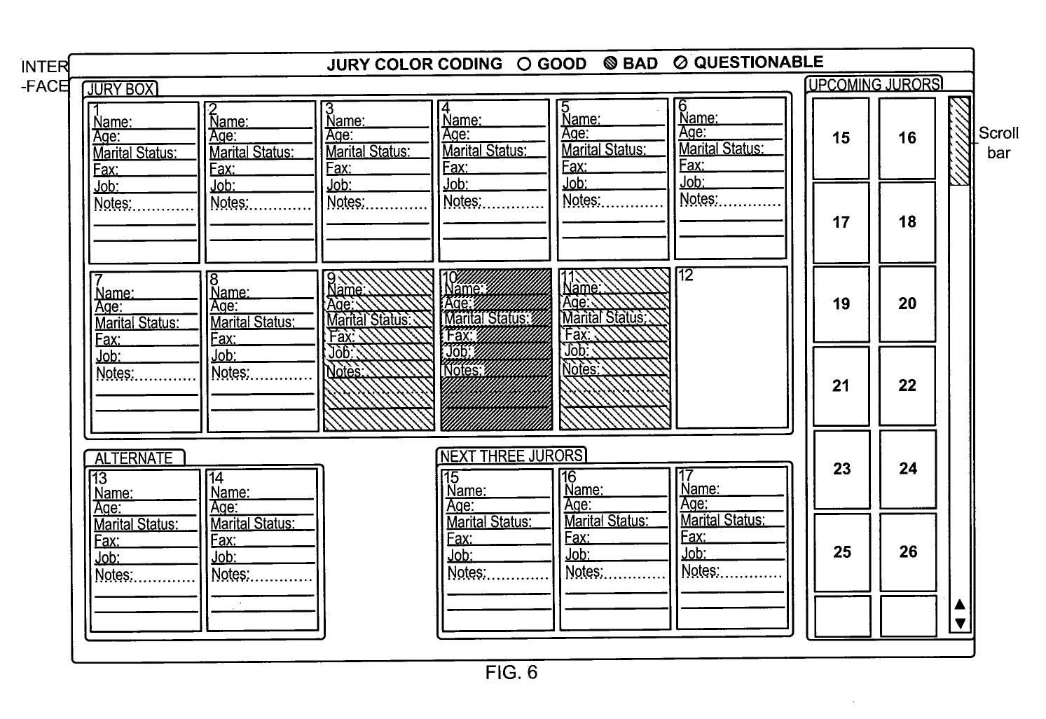

As noted above, jurors of a pool can be organized and/or sorted into a number of different groups. FIG. 6 illustrates a graphical display following sorting/organization according to the present invention. Illustrated groups include the current panel identified as the “jury box”. As shown, 12 juror cards are illustrated corresponding to jurors currently identified as composing the current jury panel. As noted, juror cards can be coded (e.g., color coded, etc.) for designation and information management. Juror cards can include patterning for inputting various information on the corresponding jurors (see, e.g., above). Groups can further include prospective jurors, and can optionally be organized in subgroups, such as the next three jurors, and remaining prospective jurors, with prospective jurors optionally arranged in a queue. During operation, as jurors are removed from the jury box the next prospective juror is moved from the prospective juror queue and into the jury box or current panel. As will be recognized, a computer system embodiment may be designed for various user interface configurations, allowing the user to select and interface with jury organization, different juror cards, e.g., by double-clicking, right-click, select, drag and drop, and the like. Various processes, steps, and additional system functionalities can be added to enhance organization and management of jurors during the selection process as described. Further, various different displays and specific graphical user interface can be designed while maintaining the basic functional parameters of the current system, and will be included in the present invention.

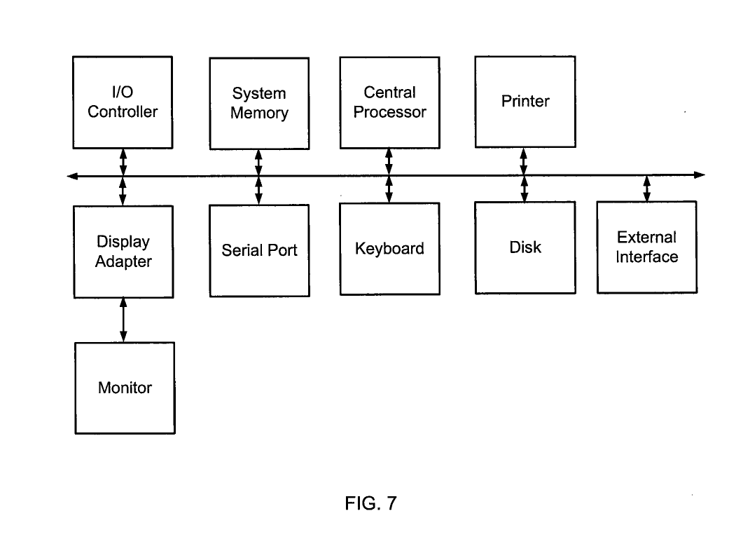

FIG. 7 shows typical components or subsystems of a computer apparatus for implementation of a method or process of the present invention. The subsystems shown in FIG. 7 are interconnected via a system bus. Additional subsystems such as a printer, keyboard, fixed disk, monitor, which is coupled to display adapter, and others are shown. Peripherals and input/output (I/O) devices, which couple to I/O controller, can be connected to the computer system by any number of means known in the art, such as serial port. For example, serial port or external interface can be used to connect the computer apparatus to a wide area network such as the Internet, a mouse input device, or a scanner. The interconnection via system bus allows the central processor to communicate with each subsystem and to control the execution of instructions from system memory or a disk, as well as the exchange of information between subsystems. The system memory and/or the disk may embody any computer readable medium.

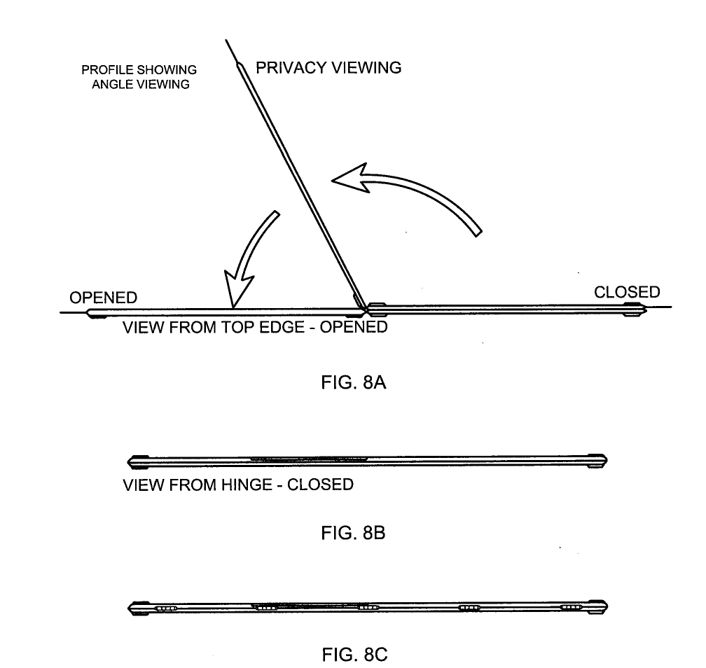

In one embodiment, a jury board can include a design and construction in a shape resembling a legal size folder, which may provide more industry recognition, easy handling, and travel compactness. An example of such an embodiment is illustrated with reference to FIGS. 8-10.

FIGS. 8A through 8C illustrate views of a jury board having a “legal folder” design. FIG. 8A shows a side profile view, illustrating hinged movement of the board from a substantially closed or compact configuration to an opened configuration. FIG. 8B provides a top edge view of the jury board in an opened configuration. FIG. 8C illustrates a view of the hinged portion where the board is in a closed configuration. The jury board system's hinge design allows the user to have it closed, e.g., for travel, or opened, e.g., either at an angle for viewing privacy or flat like a book during voir dire, with the configuration selected by the user.

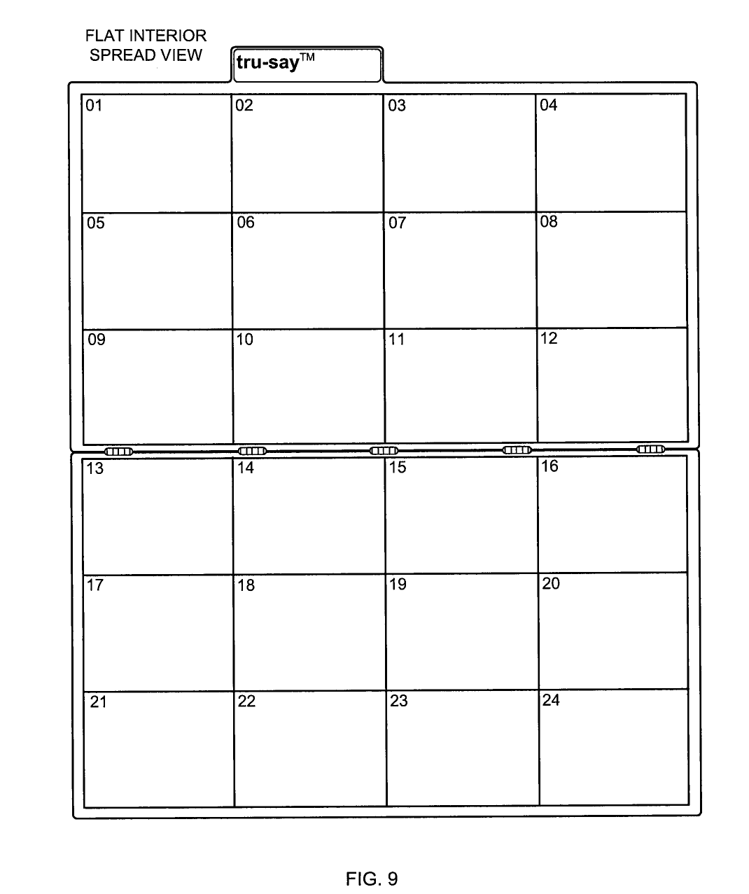

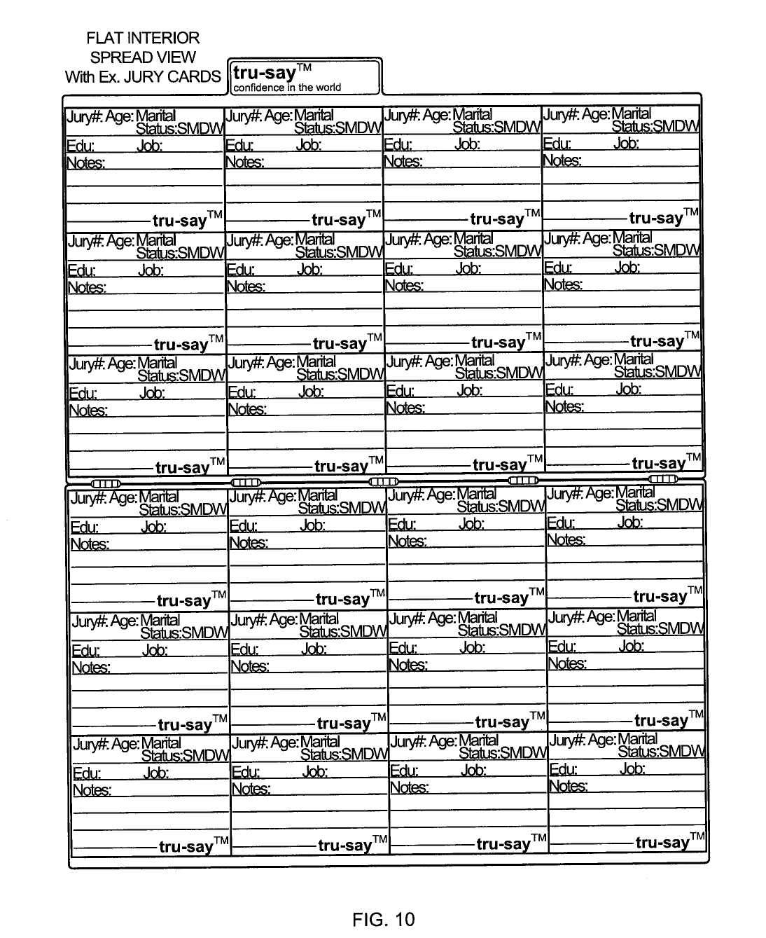

FIG. 9 shows in interior surface view of the jury board embodiment as in FIGS. 8A-8C. As illustrated, a surface of the board can be patterned for designed positioning of jury cards. In the illustrated embodiment, areas 1 through 24 are shown for positioning of jury cards, though various numbering and pattern designs may be selected. FIG. 10 shows an interior surface view as in FIG. 9, the interior surface further including juror cards positioned on the board surface. Jury cards can include various designs, including those as identified above (see, e.g., FIG. 1). The board surface and/or jury cards can include a design or configuration for positioning of jury cards on the board surface and holding the cards securely in place. For example, a magnetized interior surface of the board may be selected to accommodate for magnetic jury cards (e.g., 24 cards), enabling the user to add, remove and keep track of juror selection with ease. Jury cards have a reusable writing surface with easy wipe off.

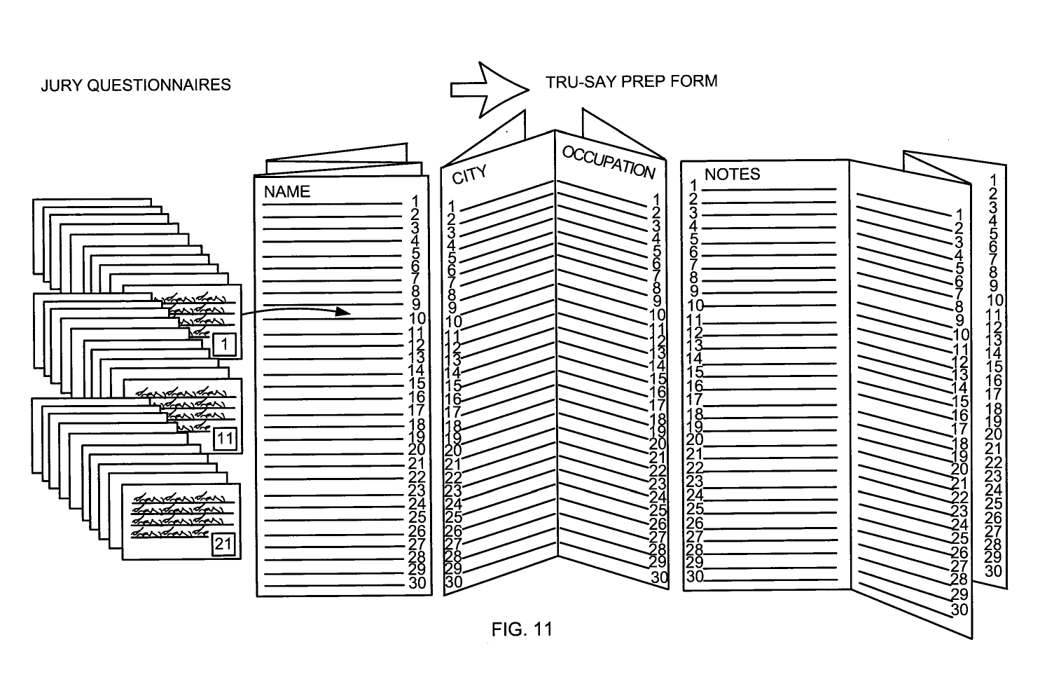

In another embodiment, a system of the present invention can optionally further include a jury information sheet or “prep form”, as illustrated in FIG. 11, as a complimentary or additional system component. FIG. 11 shows a foldable information sheet or prep form in various configurations (right side of FIG. 11). A user receives potential jurors filled out questionnaires, the user transfers or writes all relevant info onto the prep form (one line per juror based on assigned number) for use during the voir dire process. A prep form can include additional room for additional notes should a juror provide information during the questioning process. The form helps a user or attorney stay organized allowing an efficient use of time and more direct contact with the jurors. The same juror information can be transferred or written on the jury cards for easy referencing and queue management to visualize who is going to be the final jurors. Preprinted and scored card stock packs of a to be determined amount can be designed or configured for one time use only.

The jury information sheet allows for quick access of information, a place for note taking, as well as a discrete panel for scoring/rating of jurors by legal council, all while maintaining a composed, organized and professional appearance in front of the jury pool. This information gathering sheet directly assists council in using the invention system by efficiently gathering all important jury data on a single folded sheet.

The present invention can include a kit or package including one or more components as described herein. For example, a kit can include a jury selection kit having a jury board and a plurality of juror cards for use in conjunction with the board, as well as one or more prep forms, as described above. A kit can further include instructions for use, as well as writing implements, erasing tools, and the like. For software embodiments, a kit can include a computer readable media, such as a compact disc or DVD, as well as instructions, or may be provided via network access (e.g., internet access) for download.

Various other modifications and alterations in the structure and method of operation of this invention will be apparent to those skilled in the art without departing from the scope and spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. A method for improved organization and management of a jury selection process, comprising:
generating a juror card for each of a plurality of jurors in a jury pool, each juror card comprising information regarding the corresponding juror;
sorting the juror cards into a first group comprising a current jury panel and a second group comprising potential jurors;
positioning a plurality of juror cards on a jury board in an ordered arrangement;
removing a juror card from the first group, the removal tracking a removal of the corresponding juror from an actual jury panel; and
adding a potential juror to the first group, wherein the potential juror is removed from the second group.

2. A computer-readable medium comprising code for performing the method of claim 1.

3. A computer program product having a computer readable medium storing a set of code modules which when executed by a processor of a computer system cause the processor to render an image, the computer program product comprising:
code for receiving data comprising candidate juror information;
code for sorting candidate jurors into one of a first group comprising a current jury panel and a second group comprising potential jurors;
code for removing a candidate juror from the first group;
code for adding a potential juror to the first group, wherein the potential juror is removed from the second group; and
code for re-sorting candidate jurors into one of a revised first group and second group following the removing and adding of jurors.

4. A system for improved organization and management of a jury selection process, comprising:
a plurality of juror cards, each juror card having surface area patterned for inputting information regarding an actual juror candidate at one or more designated locations on the card surface;
a jury board having a surface area configured for positioning of a plurality of juror cards in a selected arrangement corresponding to an actual current jury panel or group of prospective jurors, wherein the juror cards are configured for removable attachment to the jury board.
